(19) United States
(12) Patent Application Publication
(10) Pub. No.: US 2014/0108543 A1
(43) Pub. Date: Apr. 17, 2014

(54) METHOD AND SYSTEM FOR MANAGING INFORMATION FOR USER PARTICIPATION

(71) Applicant: COGWARE PTY LTD, Melbourne (AU)

(72) Inventor: Jon WINDUST, Melbourne (AU)

(73) Assignee: COGWARE PTY LTD, Melbourne (AU)

(21) Appl. No.: 14/051,638

(22) Filed: Oct. 11, 2013

Related U.S. Application Data
(60) Provisional application No. 61/712,904, filed on Oct. 12, 2012.

(51) Int. Cl. H04L 29/08

(52) U.S. Cl. CPC H04L 67/10
USPC 709/204

(57) ABSTRACT

A computer implemented method and system of managing information for user participation is provided. The system and method includes assembling data indicative of information created by users participating in a designated task or conversation into a collection, generating a collection identifier for the collection and connecting the collection to a further collection if the information created by the users is related to information assembled within the further collection. An edge connection in association with the collection identifier is generated and a further collection identifier generated for the further collection. The collection and the further collection are then outputted for the users to participate in the task or the conversation based on the collection identifier for the collection and the edge connection.

### BACKGROUND

1. Field of the Disclosure

The present invention relates to a method and system for managing information for user participation. The present invention is of particular, but not exclusive, application in assembling data indicative of information created by users participating in a designated task or conversation into a collection and connecting the collection to a further collection if the information created by the users is related to information assembled within the further collection so that the collection and the further collection are outputted to the users to participate in the task or the conversation relating to that information.

2. Description of the Background Art

Communications technology, the Internet and now cloud computing, for instance, have increased our ability to create and communicate information—so much so that we now deal with a flood of information on a daily basis. We are increasingly using these technologies to collaborate with more people on many different things. However, while the ability to produce and communicate information has exploded, the ability to understand that information and to deal with that information has not increased at the same pace. Indeed, the information flood and our human limits are a barrier to leaps in advancement in creativity, innovation and capability.

In addition, while understanding can be achieved by the thoughts of individuals, it needs to be expressed and communicated to others for it to assist in the advancement in creativity, innovation and capability, etc. For example, in a conversation between two individuals, an understanding is shared through the use of expressions between the two individuals. Thus, the conversation could be considered to represent the understanding and the conversation assisted the users to increase their ability to understand the information discussed.

One existing method of managing conversations relating to information is email. Email enables the dissemination, discussion and understanding of information to a number of recipients. However, email is limited in terms of, for example, maintaining track changes and, in many cases, can increase complexity rather than reduce it. Another existing example is bulletin boards, now often called online groups. The bulletin boards were an early technology for enabling discussion, sharing and understanding of information. Blogs are another existing tool for the dissemination, discussion and understanding of information. Furthermore, telegraph, telephone, digital audio communications and video are other existing technologies that have contributed in some way to managing the understanding of information. However, these technologies have been developed more as a way of communicating information, rather than to increase the understanding of it for user participation relating to the information.

Furthermore, social enterprise systems have been promoted as a solution to dealing with the volume and complexity of information we deal with. However, they are mostly a copy of what we see in the social network technology that preceded it. Social technology has been designed to suit socialising rather than participating on and dealing with information, and thus does nothing to enable greater understanding and ability to deal with more information. In many cases social technology will, in fact, result in an even greater flood of information and a reduction in the levels of complexity on information that we can deal with.

### SUMMARY

According to one aspect of the present invention, there is provided a computer implemented method of managing information for user participation, the method including:
assembling data indicative of information created by users participating in a designated task or conversation into a collection;
generating a collection identifier for the collection;
connecting the collection to a further collection if the information created by the users is related to information assembled within the further collection;
   generating an edge connection in association with the collection identifier and a further collection identifier generated for the further collection; and
   outputting the collection and the further collection for the users to participate in the task or the conversation based on the collection identifier for the collection and the edge connection.

In an embodiment, the information includes resources provided by providers. It will be appreciated by those persons skilled in the art that the word “resources” is used to encompass information contained in, for example, files, documents, spread-sheets, presentations, calendars, communications, information and also physical resources, such as printers, etc. That is, resources, such as files and web sites containing information, can be accessed for participation thereon using the above method. The resources can also be considered connections or links to hosted information to be understood and participated on by the users. The information may already exist or be in the process of creation by the users.

In addition, it will be appreciated by those persons skilled in the art that the word “task” encompasses activities, goals and plans that need to accomplished, as well as contributing to wikis (e.g., wiki web sites), polls, walls, events, blogs, webpages, etc. It will also be appreciated that the term “conversation” encompasses communications, such as posts and comments, in relation to the information. For example, posts can be either information itself or comments about the information in some written symbolic form or recorded form such as audio or video. Comments are made in response to posts or other comments and can also be in written symbolic form or recorded form such as audio or video.

It will be appreciated by those persons skilled in the art that the task or the conversation relationship between the information in the first collection and in the further collection can be either a user designated relationship or an automatically designated relationship based on some criteria, such as the relationship being that the information is created by the same user. Furthermore, it will be appreciated that more than one further collection can be connected to the collection based on one or more such criteria.

In an example, the task includes a number of tasks or activities to be accomplished as well as, for example, goals (e.g., aspiration to achieve some end-point), projects (e.g., a collection of tasks to achieve some planned outcome), and strategies (e.g., plans to achieve some vision). Conversations include a collection of posts and comments on information in the form of resources by participants, and data indicative of the participants and the resources is also assembled in the collection. It will be appreciated by those persons skilled in the art that a collection of conversations or tasks represents a total understanding for a particular conversation or task. Accordingly, the collection provides a mechanism for the users to participate and carry out of the task or conversation with greater understanding than if the task or conversation was participated on in isolation. For example, in relation to a strategy, the strategy includes a number of connection collections for goals, projects, tasks and conversations required to fulfil the strategy. Thus, a user participating in the strategy can view the outputted connected collections, which represent the current state of the strategy, to better participate in the strategy.

In preference, the method assembles data on communications on some information in a collection to provide a way of assembling units of understanding on the information out of smaller units of understanding on the information. For example, the method assembles data indicative of the present communications in one collection and assembles the prior communications on the information in another collection and connects the collections to enhance the users understanding of the information. Accordingly, in the example, a user wishing participate in a conversation on the information receives details of the previous conversation to increase the user's understanding of the information. The method thus reduces the considerable human effort and capacity spent understanding information where an existing understanding already exists by reducing the duplication of effort. Indeed, if an understanding already exists and it is by a source you can trust, why not use it and put the saved effort toward some other function. Furthermore, as will be appreciated by those persons skilled in the art, the number of things a person can understand is limited by time and intellectual ability, but this number can be increased by giving people access to the understandings of others along with the related information. With reference to another example, if a group of people are collaborating on a task, the method provides the ability for the users to view and utilise their collective understandings for the totality of the task. It also provides the ability to discover related existing understandings for that piece of information and multiple understandings for the same information can be easily found and accessed.

In an embodiment, the connecting of collections is performed using an understanding graph based on the generated edge connection and collection identifiers, which provides the ability for the user to participate in the task or the conversation, as well as to store, process and manipulate the collections in a desired way. Furthermore, mathematical graph theory can then be applied to understandings. For example, the method uses graph theory to create the greater units of understanding in the form of collections which enables existing techniques, such as the Program Evaluation and Review Technique (PERT), to be applied to the collections. Additionally, graph theory will also enable capabilities such as examining the character of the understandings—in the form of the connected collections—and predicting the likelihood of the success or failure of some endeavour or task.

In an embodiment, the resources are hosted by providers in data communication with a controller for implementing the above method, and the controller is also in data communication with the users. That is, in the embodiment, the users participating in the task or the conversation receive an outputted collection of that information and any further collections connected to that collection over the Internet via the controller.

In one embodiment, the controller is interposed between the users and the providers to implement the method. In another embodiment, the controller and the providers of the resources are hosted by the same system which is in data communication with the users. Nonetheless, once a user becomes a participant in a collection, they can then participate in the task or conversation on the hosted information through the controller or through the providers directly.

In an embodiment, the method further includes storing the collection identifier and the edge connection in a database. In an example, the database is hosted by the controller. In another example, the database is in data communication with the controller or it is a distributed on the servers of the providers. In any case, the further collection identifier generated for the further collections is also stored in the database.

In an embodiment, the method further includes assembling data indicative of the users participating in the task or the conversation in the collection, whereby the users include active and passive participants in the task or the conversation. In the embodiment, the active participants have been invited to participate in the task or the conversation (by, for example, another active participant) and the passive participants have not been invited to participate in the task or the conversation, but may be able to participate on some level depending on a designated security configuration for the passive participants. Thus, for example, the active and passive participants are those users that are participating in the task or conversation by, for example, making or viewing/listening to posts and comments. Furthermore, it will be appreciated that the users can be individuals, part of groups and members of organisations. In this case, for example, users belonging to the same organisation grouping are assembled into a collection (e.g., connected) and are assigned security permission to participate in the task or the conversation. In relation to the example of a wall, users can access a stream of update notifications about collections they are participating in and collections participated in by their connections (e.g., related users) which are discoverable to the user. The wall can also be used to create new collections that are automatically made discoverable to the connections of the users.

In an embodiment, the method further includes removing the security permissions for said users to participate in the task or the conversation in the collection in response to the data indicative of said active and said passive participants being removed from the collection.

In an embodiment, the method further includes classifying the collection with one or more designated keywords such that the collection is searchable by the users based on the one or more designated keywords. Preferably, the method further includes the users classifying the collection with one or more user designated keywords such that the collection is searchable by users who have classified the collection based on the one or more user designated keywords. The collections are categorised automatically or are categorised by the users for later searching, grouping and filtering of the collections. In addition, the information created by users can be designated an importance rating to influence whether they are assembled into a collection; for example, posts and comments could be ignored and not collected and thus not displayed to users based on how the users rated the posts and comments in the collection.

In an embodiment, the method further includes allocating discoverability permissions for the users to control user discovery of the collection. In the embodiment, the method further includes allocating the discoverability permissions to the collection for users based on whether the users are active or passive participants in the task or the conversation in the further collection.

According to another aspect of the present invention, there is provided a system for managing information for user participation, the system including:
a collection module for assembling data indicative of information created by users participating in a designated task or conversation into a collection, wherein the collection module generates a collection identifier for the collection;
a connection module for connecting the collection to a further collection if the information created by the users is related to information assembled within the further collection, wherein the connection module generates an edge connection in association with the collection identifier and a further collection identifier for the further collection; and
   an output module for outputting the collection and the further collection for the users to participate in the task or the conversation based on the collection identifier for the collection and the edge connection.

In an embodiment, the collection module stores the collection identifier and the connection modules store the edge connection in the above mentioned database. In addition, the connection and collection modules, sometimes referred to as connection and collection mechanisms, manage how the basic units of understanding can be formed into greater units of understanding and how these can combine into even greater units. For example, the modules are hosted by the controller and control how resources, posts, comments and participants can combine to form a conversation and how tasks can be formed of conversations as described above. The collection module also creates the above-mentioned understanding graph to control how the information can be formed into collections and to enable the information and collections to be connected to, and is some cases embedded into, other collections.

This enables greater units of understanding to be formed by connecting and embedding information and connections. For example, a task may be created and have a number of resources, posts and comments and also a number of embedded conversations and other tasks. A standard connection is made between information created by the users and other information or a collection in which it was created by the user. An embedded connection is made between information created by the user and other information or a collection in which it was embedded and not created.

For example, the connection mechanism works by making connections with components created by users such as resources, posts, comments, and participants, as well as collections, which have data previously assembled by the collection mechanism. It does this by treating components and collections as vertices on a graph. The connections are the edges on the vertices and the types of connections permitted are: component to component; component to collection; and collection to collection. Collections can have an outward connection (e.g., edge) to another collection. They can also exist on their own without any outward connections. Components, however, must have an outward connection (e.g., edge) to either another component or a collection. In the example, the collections are initiated by a user who is a member or an organisation and who then becomes an active participant in that collection.

That is, the components of a collection include the resources, which are connections or links to user created information such as a files, posts which are information created by users, and comments, which are information created by users in response to posts, and participants, which are users that can, for example, make, read, listen or view posts and comments. The collections include the tasks, conversations, goals, projects, strategies, etc., which are a collection of the components and, in some cases, other collections.

According to another aspect of the present invention there is provided computer program code which when executed implements the above method.

According to another aspect of the present invention there is provided a tangible computer readable medium including the above program code.

According to another aspect of the present invention there is provided a data file including the above program code.

### BRIEF DESCRIPTION OF THE DRAWINGS

Embodiments of the present invention will now be described, by way of example only, with reference to the accompanying drawings, in which:

FIG. 1 is a schematic diagram of a system for system for managing information according to an embodiment of the present invention;

FIG. 2 is a flow chart of a method of managing information according to an embodiment of the present invention;

FIG. 3 is a diagram of connected collections according to an embodiment of the present invention;

FIG. 4 is a flow chart of a method of collecting information according to an embodiment of the present invention;

FIG. 5 is a further flow chart of a method of collecting information according to an embodiment of the present invention;

FIG. 6 is a diagram illustrating discoverability permissions according to an embodiment of the present invention;

FIG. 7 is a diagram illustrating further discoverability permissions according to an embodiment of the present invention;

FIG. 8 is a diagram illustrating further discoverability permissions according to an embodiment of the present invention;

FIG. 9 is a diagram illustrating further discoverability permissions according to an embodiment of the present invention;

FIG. 10 is a flow chart of a method of evaluating whether a user can passively participate in a collection according to an embodiment of the present invention;

FIG. 11 is a flow chart of a method of evaluating whether a user can invite either users to participate in a collection according to an embodiment of the present invention;

FIG. 12 is a design of a user interface according to an embodiment of the present invention;

FIG. 13 is a further design of the user interface of FIG. 12;

FIG. 14 is a further design of the user interface of FIG. 12;

FIG. 15 is a further design of the user interface of FIG. 12;

FIG. 16 is a further design of the user interface of FIG. 12;

FIG. 17 is a further design of the user interface of FIG. 12; and

FIG. 18 is a further design of the user interface of FIG. 12.

### DETAILED DESCRIPTION OF THE PREFERRED EMBODIMENTS

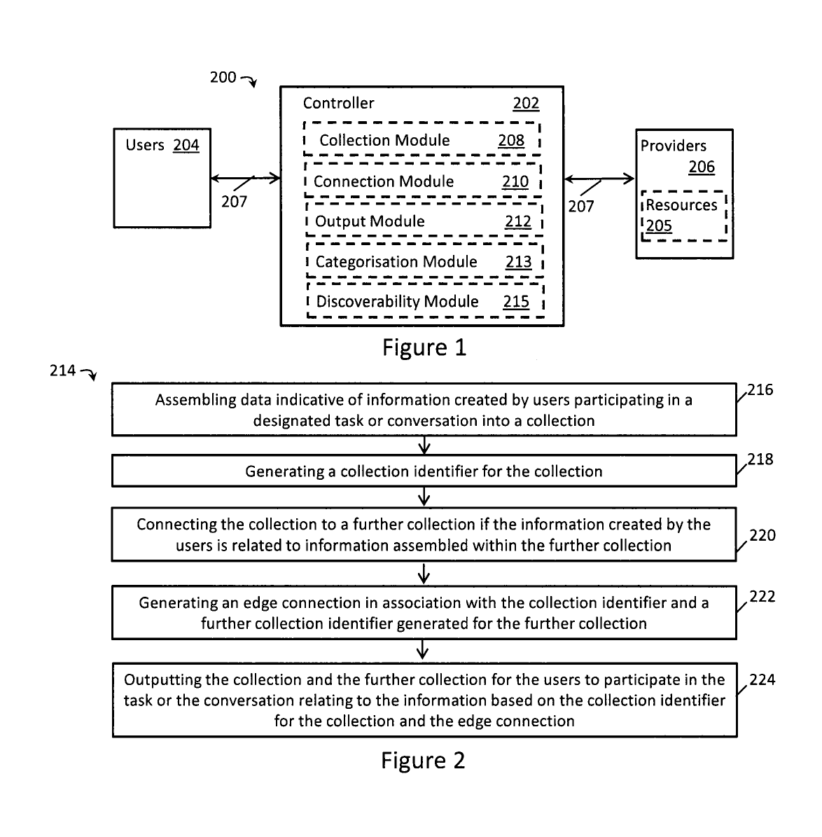

According to an embodiment, there is provided a system 200, as shown in FIG. 1, for managing information for user participation in a designated task or conversation. The information includes resources 205, which are connections to information to be understood for the task or conversation that are accessible over a communications network 207. It can be seen from FIG. 1 that the users 204 access an intermediary controller 202 for managing the information over the network 207 so that the users 204 can access the resources 205 provided by the providers 206. It will be appreciated by those persons skilled in the art that the intermediary controller 202 can also be implemented at either the user side or the provider side so that the users 204 can access the resources 205 over the network 207, which is, for example, the Internet. It will also be appreciated that the network 207 could also be a private network.

The controller 202 implements a number of modules to manage the information including a collection module 208 for assembling data indicative of information created by users 204 participating in a designated task or conversation into a collection. The collection module 208 also generates and stores a collection identifier for the collection in a database. The database can be implemented locally in a memory of the controller 202 or can be in data communication with the controller 202 over the network 207. The controller 202 also implements a connection module 210 for connecting the collection to a further collection if the information created by the users 204 is related to information assembled within the further collection. As described, the relationship between the information can be user specified or it can be automatically designated, such as being based on the creator of the information, and the designated criteria is stored in the database. In any case, the connection module 210 generates and stores an edge connection in association with the collection identifier and a further collection identifier generated for the further collection in the database.

It will be appreciated by those persons skilled in the art that the collection module 208 and the connection module 210 may not be co-located in the controller 202. For example, the collection module 208 is located on a user computer while the connection module 210 is implemented by the controller 202. In any case, the connection module 208 assembles data indicative of the user 204 participating in a task or conversation and information created by the user 204 in relation to the task or conversation into a collection, and generates a collection identifier accessible to the controller 202. If another user creates information that is assembled into a further collection, the central collection module 208 or the distributed collection module 208 generates a further collection identifier also accessible to the controller 202. In this way, the connection module 210 can connect the collections, based on a user 204 designated relationship criteria that is also stored with respect to the collection identifiers, and generate an edge connection.

The controller 202 also includes an output module 212 for outputting the collection and the further collection for the users 204 to participate in the task or the conversation based on the collection identifier for the collection and the edge connection. Accordingly, users 204 can view the outputted collection and one or more related further collections to have a better understanding of the task or conversation in order to better participate in it.

As described, the collections and their connection can be realized in an understanding graph based on the generated edge connections and collection identifiers. The connection 210 and collection 208 modules form collections for designated tasks or conversations based on the information created by users 204 participating in the tasks or conversations. In this way, a conversation can be a collection of assembled data indicative of information created by users 204 in respect of the conversation, e.g., a collection of user posts, and can be connected to another collection in the form of a task having, for example, multiple conversations to perform that task.

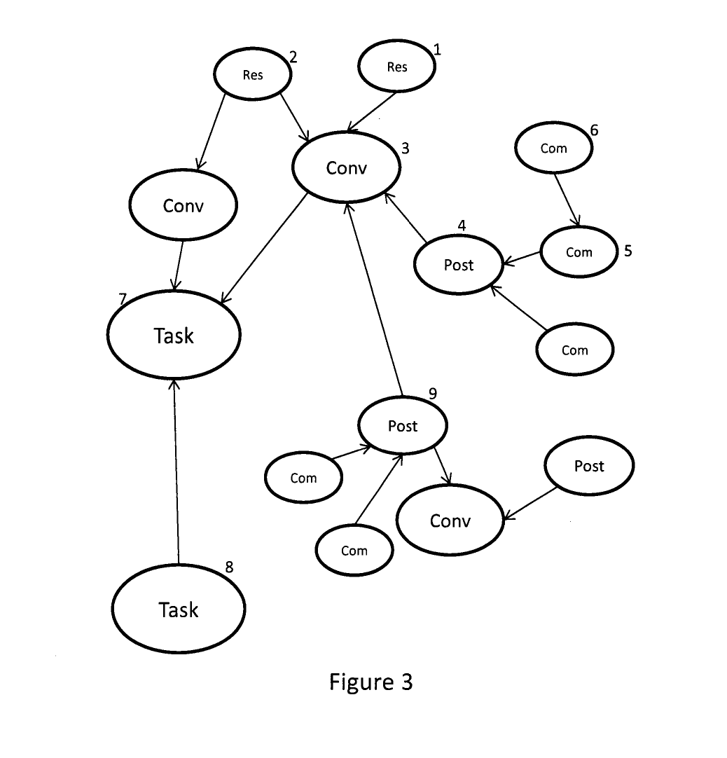

FIG. 3 shows an example of a graph where information in the form of a resource 1 is connected to one conversation 3 and another information resource 2 is connected to two conversations (including conversation 3). The conversation 3, which is a collection itself as described above, is also connected to another collection in the form of a task 7. Also, a post 4 within the conversation 3 is connected thereto and not connected elsewhere. Nonetheless, the post is made up of user comments 5 connected to the post 4 within the conversation 3. Furthermore, a comment 6 is connected to the comment 5 within the post 4, which is within the conversation 3, which is, in turn, within the task 7. Thus, the task 7 is a collection of two conversations and has another task 8 connected thereto. It can also be seen that the conversation 3 has a further post 9 connected thereto, in addition to the post 4. The post 9, however, has a standard connection with one conversation and an embedded connection with another conversation, which will be discussed in further detail below.

Accordingly, with reference to the example, a user invited to participate in the task 7 by creating information in relation to, for example, the conversation 3, receives the outputted conversation 3 and connected resources 1 and 2, as well as details of the other connected conversation to better participate in the task 7. That is, to participate in the task 7 with a greater understanding of the task 7.

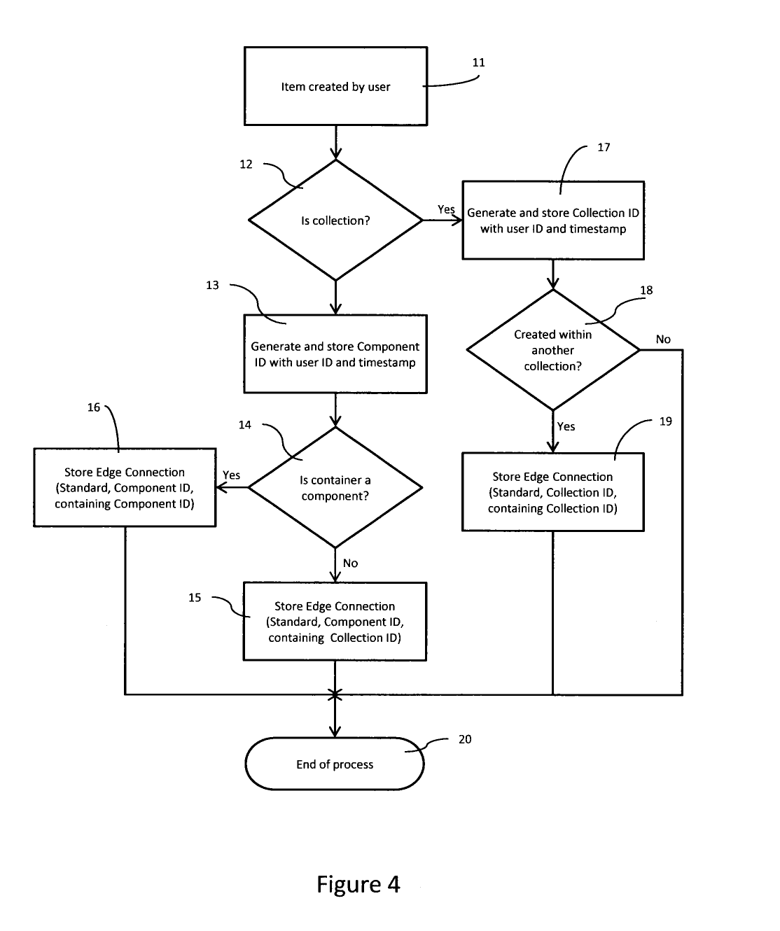

FIG. 4 shows the process followed when a user 204 creates new information in the form of an item 11. This information might be a component of a collection or a collection 12, such as a conversation, post, comment, task, resource, etc. Components are stored 13 with a generated component ID and the user's ID and a timestamp. Where components are created within a collection, a standard edge connection between the two items is stored 15 with the pairing component ID and collection ID. The direction of the edge connection is outbound from the component to the collection. Where components are created in response to (e.g., as a connection to) another component, a standard edge connection between the two items is stored 16 as a standard connection with the pairing component ID and containing component ID. Again, the edge connection is outbound from the component to the containing component. If the item 11 is a collection 12, the collections are stored 17 with a generated collection ID and the user's ID and a timestamp. Where a collection was created within another collection, a standard edge connection is stored 19 with the pairing collection ID and containing collection ID. No edge connection is stored if a collection is not created within another collection.

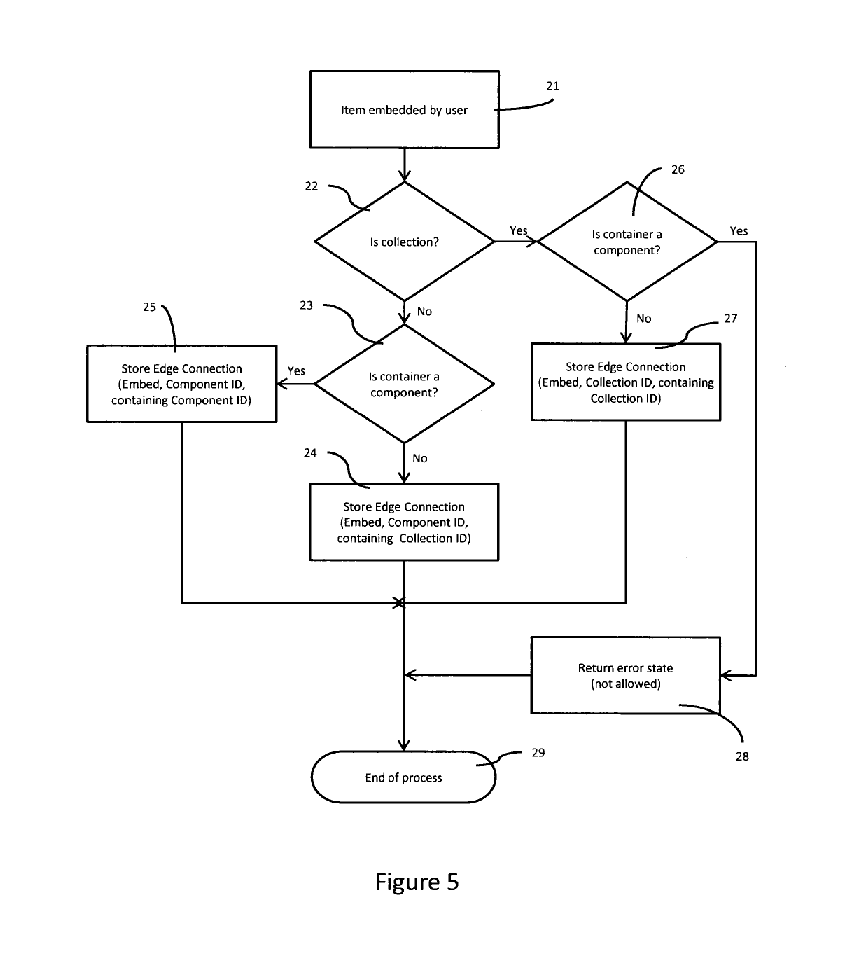

FIG. 5 shows the process followed when a user 204 creates new information in the form of an embedded item 21. In this process, users 204 can embed 21 components and collections into other components and collections. Where a component is embedded within a collection an embed edge connection is stored 24 using the pairing component ID and containing collection ID. Where a component is embedded within a component, an embed edge connection is stored 25 using the pairing component ID and containing component ID. Where a collection is embedded within another collection, an embed edge connection is stored 27 using the pairing collection ID and containing collection ID. Collections, however, cannot be embedded within components 28.

The controller 202 further includes a categorisation module 213 for classifying the collections with one or more designated keywords such that the collections are searchable by the users 204 based on the designated keywords. This categorisation mechanism is, in an example, a set of information used to classify a collection. For example, the designated keywords are user-designated for later searching, grouping and filtering of the collections, and the collections can have both an overall categorisation and can also have individual participant categorisation which applies only to that individual.

The overall categorisation is a set of designated keywords or tags. For example, the keywords for a collection about financial reports might include “financial reports, profit and loss, balance sheet, financial results”. Where a list of collections are outputted and displayed to users, the users can choose to view only those matching a set of keywords or tags. In addition, as described, the individual participants can also categorise collections. In this case, the users 204 can override the overall categorisation with their own keywords/tags. Individual participants can also assign a priority number to collections to indicate their importance so that collections can be sorted by priority.

The controller 202 also includes a discoverability module 215 for allocating discoverability permissions for the users 204 to control user discovery of the collection. This discoverability mechanism includes, for example, a set of criteria for controlling who can find the collections. For example, only active participants in one collection can find the collection. In addition, allowable resource permissions for active and passive participants to participate in the collection by accessing the information provided by the resources 205 include: none; read only; read/write; read/write/create; read/write/create/delete. Further details of the resource permissions is contained in the co-pending application filed on Sep. 28, 2012 (U.S. provisional patent No. 61/707,412) entitled “A method of managing user security permissions for access to resources”, the contents of which are incorporated herein by way of reference.

The criteria for controlling who can find a collection also includes the following choices: no-one (the collection is not discoverable); anyone; anyone connected to the collection owner; any active participant in any child collection; any active participant in any parent collection; and any active participant in any connected collection. In addition, the discoverability mechanism also includes the ability to restrict discoverability based on user properties, such as restricting the above choices to only people within a grouping in an organisation which owns the collection and restrict the above choices to collections within a number of connections. That is, with reference to the graph of FIG. 3, if the discoverability permissions is set to users participating in the task 7 within one connection, only users of the conversations 3 can view the task 7 and the conversations 3—resource 2 is not outputted.

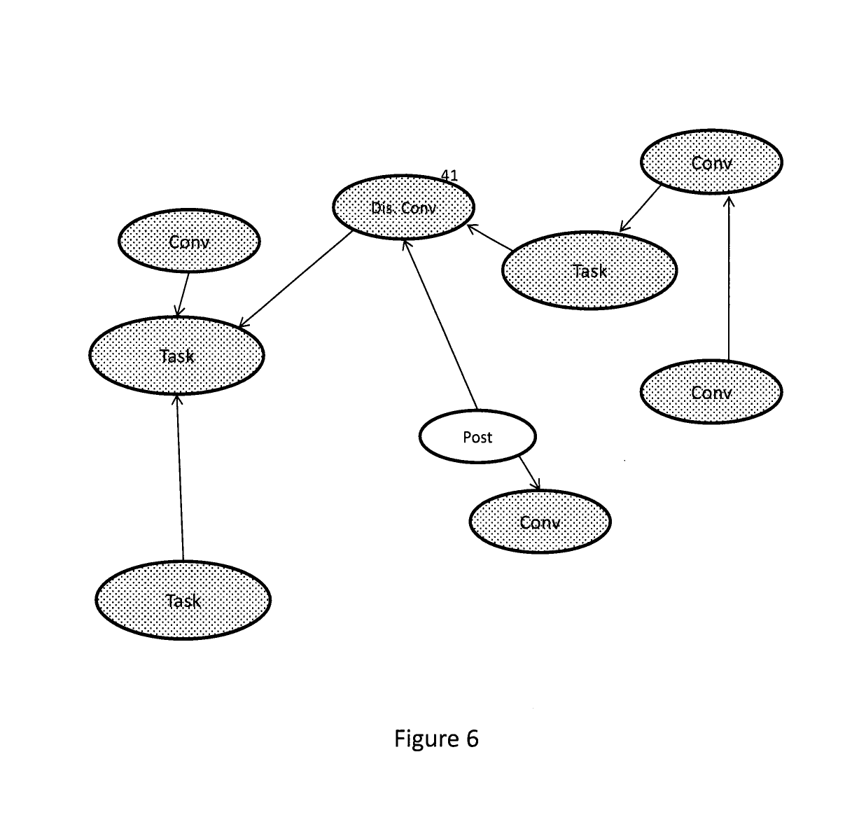

FIG. 6 illustrates another example in more detail: the scenario where a user 204 with permission to set discoverability, chooses the “anyone” option. In this example, vertex “Dis. Cony” 41 is a conversation where a user 204 has set discoverability to anyone and, in this scenario, any user 204, regardless of whether they are participating in a collection, can discover the conversation 41. That is, as described, data indicative of user participation in a collection is assembled into that collection (e.g., using user ID) so that discoverability permissions can be allocated for the users. It can be seen in the examples shown in FIGS. 6 to 9 that the shaded collections are discoverable by users of any of those collections. As described, the users can be active or passive participants in the collection, such as a task, and different discoverability permissions can be set accordingly.

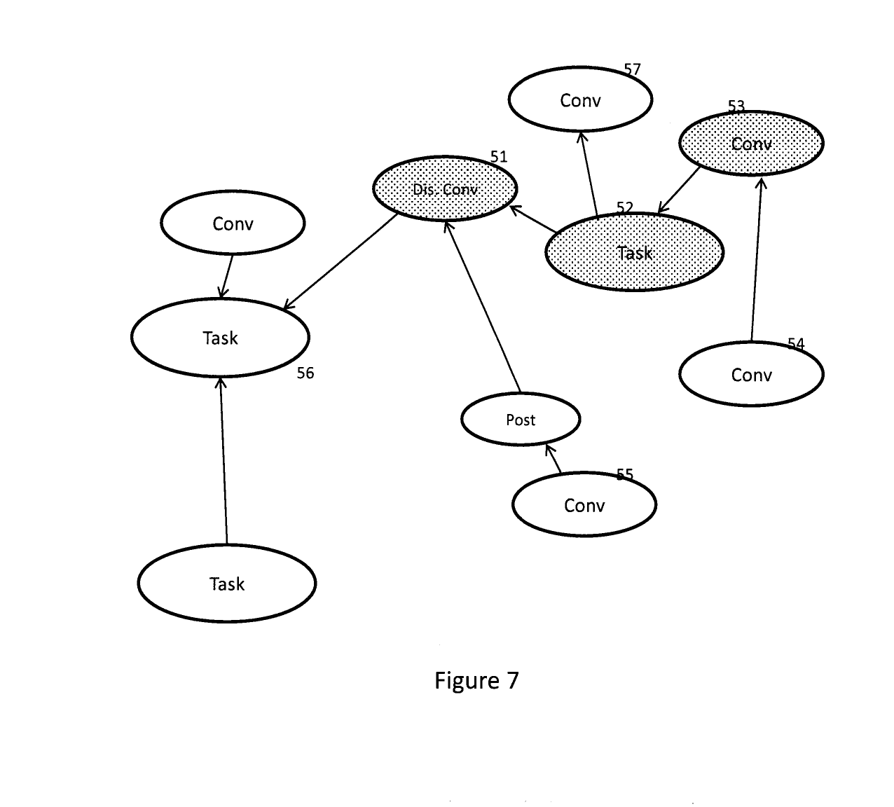

FIG. 7 illustrates the scenario where a user 204 with permission to set discoverability, chooses the “any active participant in any child collection” option. In this example, the user 204 also chooses to restrict this to collections within 2 connections. In FIG. 7, the discoverable conversation 51 has three child collections: task 52, conversation 53 and another conversation 54. Active participants in task 52 and conversation 53 can therefore discover conversation 51. However, because the discoverability has been limited to within two connections, participants in conversation 54 cannot discover conversation 51. Conversation 55 is within two connections of conversation 51. However, only collections connected to other collections are to be evaluated and conversation 55 is connected to a post component that is within the conversation 51. Thus, participants in conversation 55 therefore cannot discover conversation 51. Participants in task 56 also cannot discover conversation 51, because task 56 is not a child vertex—it is a parent vertex. Conversation 57 is within two connections of Conversation 51; however, participants in conversation 57 cannot discover conversation 51 because it is a parent connection to task 52 rather than a child connection to task 52.

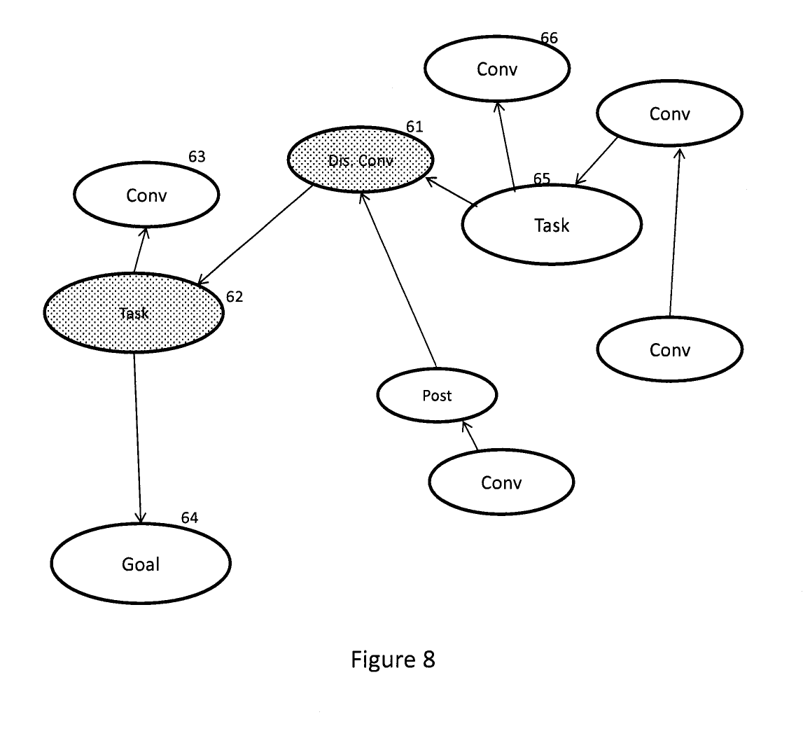

FIG. 8 illustrates the scenario where a user 204 with permission to set discoverability, chooses the “any active participant in any parent collection option”. In this example, the user 204 also chooses to restrict the discoverability to collections within one connection. The discoverable conversation 61 has just one parent 62; thus, participants within task 62 will be able to discover conversation 61. Conversation 63 and goal 64 are parents of task 62, which is a parent of discoverable conversation 61, but, because the selection has been restricted to collections within one connection, participants in conversation 63 and goal 64 will not be able to discover conversation 61. Also, participants in task 65 cannot discover conversation 61 as task 65 is a child of conversation 61, not a parent, and participants in conversation 66 cannot discover conversation 61 as, while conversation 66 is a parent of task 65, task 65 is a child of conversation 61, and conversation 66 is more than one connection from conversation 61.

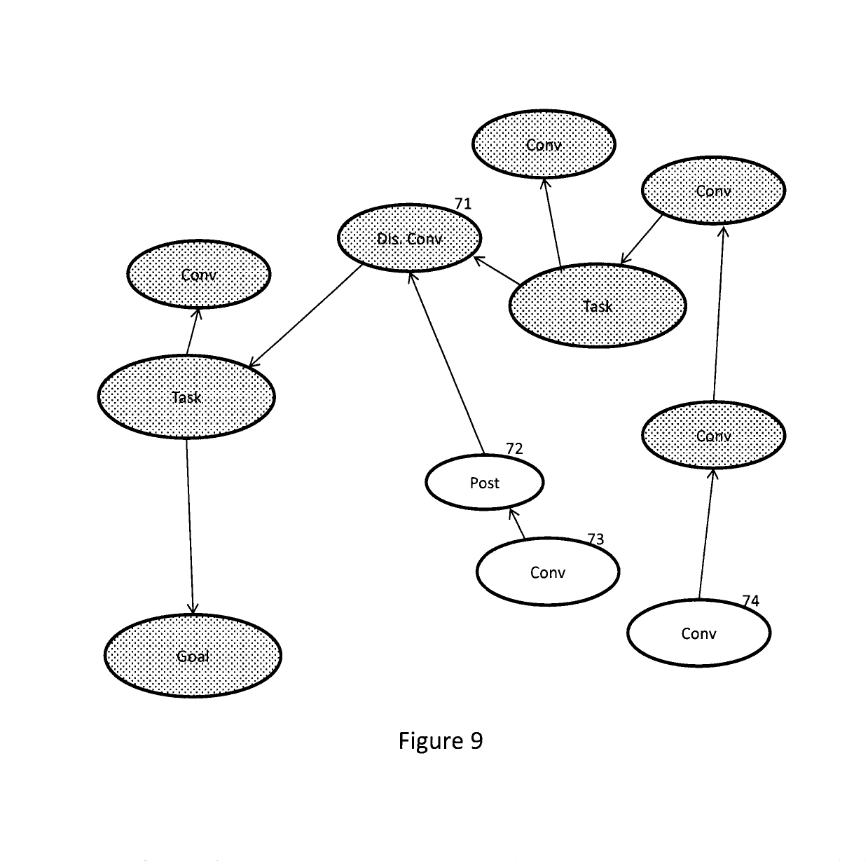

FIG. 9 illustrates the scenario where a user 204 with permission to set discoverability, chooses the “any connection collection option”. In this example, the user 204 also chooses to restrict this to collections within three connections. Even though the “any connection collection option” has been chosen, participants in conversation 73 will not be able to discover conversation 71 because post 72 is not a collection, but a component. Participants in all other collections can discover conversation 71, except for the participants in conversation 74 as conversation 74 is not within the required three connections to conversation 71.

The discoverability module is also configured to allocate discoverability permissions for passive participants in the collection. As described, the discoverability mechanism includes a set of criteria for controlling who can find the collections and the passive mechanism is a set of criteria for determining how users 204 who are not active participants in a collection can gain access to it and what they can see and do in the collection.

For example, if a collection has been created by a user 204 who is an organisation user, the criteria includes: can people within the owner's (e.g., creator) organisation who discover this collection participate in a passive way; and can people external to the owner's organisation who discover this collection participate in a passive way. The choices in response to the criteria are: no; yes; and only by requesting permission to become a passive participant.

In another example, further criteria controlling access include: whether to allow internal passive participants to see the list of active participants; whether to allow external passive participants to see the list of active participants; what are the default resource permissions for internal passive participants; what are the default resource permissions for external passive participants; whether to allow internal passive participants to see posts and comments; whether to allow external passive participants to see posts and comments; whether to allow internal passive participants to embed part or all of this collection into another collection; and whether to allow external passive participants to embed part or all of this collection into another collection.

If a collection has been created by a user 204 who is not an organisation user, the criteria includes: can people who discover this collection participate in a passive way; are passive participants allowed; can people request passive participation; whether to allow passive participants to see the list of active participants; what are the default resource permissions for passive participants; whether to allow passive participants to see posts and comments; and whether to allow passive participants to embed part or all of this collection into another collection. The choices to his criteria are also: no; yes; and only by requesting permission to become a passive participant. In some cases, if passive participants are not allowed, and people cannot request to participate, users cannot access a collection without being invited.

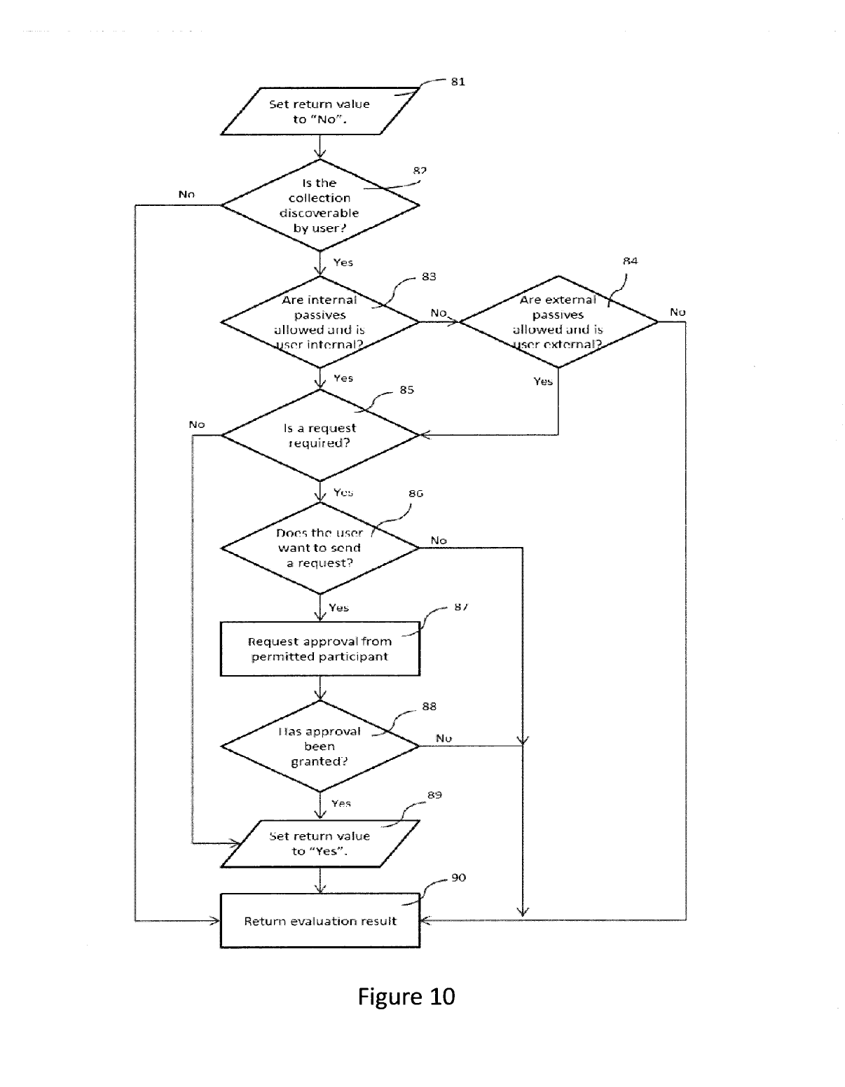

FIG. 10 illustrates the evaluation process used to determine whether an individual user 204 can passively participate in a collection. However, before a user 204 can passively participate in a collection, it must first be discoverable 82. The collection must then allow either internal 83 or external 84 passive participants, where internal 83 and external 84 refers to whether the participants are part of an organisation belonging to the owner of the collection. For example, if only internal passive participants are allowed 83, the user 204 must be within the same organisation as the owner of the collection. Passive participation may also be allowed without the need for a user to request permission, or it may require a user to request permission 85 before they can participate. If the user 204 wants to request approval 86, a request is sent to individuals 87 within the collection permitted to approve such requests. Approval can then be granted 88 or denied to passively participate.

In an embodiment, a permissions mechanism controls what participants can do within a collection and is implemented by the controller 202. For example, a user 204 who creates a collection always receives all permissions which cannot be revoked unless another participant has full permissions. The user's 204 organisation becomes the owner of the collection if they are a member of an organisation.

In the embodiment, the permissions mechanism contains two types of permissions: a collection policy permission; and an individual participant permission. Thus, if the user 204 who creates a collection is an organisational user, these collection policies can be set: who can assign ownership of the collection; who can set discoverability for internal users 204; who can set discoverability for external users 204; who can invite internal users 204; who can invite external users 204; who can approve participation requests from internal users 204; who can approve participation requests from external users 204; who can control the invitation criteria for passive participants; who can remove internal participants; who can remove external participants; who can delete the collection; who can set categorisation criteria; who can embed components; who can embed other collections; who can create a new collection connected to this one; who can access resources 205; who can create resources 205; who can modify resource 205 details; who can remove resources 205; who can set permissions for the collection; who can view the active participant list; who can view posts and comments; and who can embed part or all of this collection into another collection. One of these three options can be set for each of the above policies: any active participant within a selected organisation grouping; any active participant (internal or external); and only participants explicitly given permission.

If the user 204 who creates a collection is not an organisational user, these collection policies can be set: who can assign ownership of the collection; who can set discoverability for users 204; who can invite users 204; who can approve participation requests; who can control the invitation criteria for passive participants; who can remove participants; who can delete the collection; who can set categorisation criteria who can embed components; who can embed other collections; who can create a new collection connected to this one; who can access resources 205; who can create resources 205; who can modify resource 205 details; who can remove resources 205; who can set permissions for the collection; who can view the active participant list; who can view posts and comments; and who can embed part or all of this collection into another collection. One of these two options can be set for each of the above policies: any active participant; and only participants explicitly given permission.

If a participant is an organisational user, they can be assigned these permissions: can assign ownership of collection; can set discoverability for internal users; can set discoverability for external users; can invite internal users; can invite external users; can approve participation requests from internal participants; can approve participation requests from external participants; can control the invitation criteria for passive participants; can remove internal participants; can remove external participants; can delete the collection; can set categorisation criteria; can embed components; can embed other collections; can create a new collection connected to this one; can access resources 205; can create resources 205; can modify resource 205 details; can remove resources 205; can set permissions for the collection; can view the active participant list; can view posts and comments; and can embed part or all of this collection into another collection.

If a participant is not an organisational user, they can be assigned these permissions: can assign ownership of collection; can set discoverability; can invite users; can approve participation requests; can control the invitation criteria for passive participants; can remove participants; can delete the collection; can set categorisation criteria; can embed components; can embed other collections; can create a new collection connected to this one; can access resources 205; can create resources 205; can modify resource 205 details; can remove resources 205; can set permissions for the collection; can view the active participant list; can view posts and comments; and can embed part or all of this collection into another collection.

Table 1 shows a permissions truth table where the policy setting column indicates who can set discoverability for external users; that is, users 204 not part of the organisation of the owner of the collection. Also, the column showing whether a participant has been granted individual permission includes in its scope a participant being able to set discoverability for external users.

TABLE 1
permissions truth table

| | Participant | Participant | |
|---|---|---|---|
| | matches | has been | |
| | internal | granted | |
| | organisation | individual | |
| Policy Setting | grouping | permission | Result |
| Any active participant | True | True | True |
| within a selected | | | |
| organisation grouping | | | |
| Any active participant | True | False | True |
| within a selected | | | |
| organisation grouping | | | |
| Any active participant | False | True | True |
| within a selected | | | |
| organisation grouping | | | |
| Any active participant | False | False | False |
| within a selected | | | |
| organisation grouping | | | |
| Any active participant | True | True | True |
| (i.e. internal or | | | |
| external) | | | |
| Any active participant | True | False | True |
| (i.e. internal or | | | |
| external) | | | |
| Any active participant | False | True | True |
| (i.e. internal or | | | |
| external) | | | |
| Any active participant | False | False | True |
| (i.e. internal or | | | |
| external) | | | |
| Only participants | True | True | True |
| explicitly given | | | |
| permission | | | |
| Only participants | True | False | False |
| explicitly given | | | |
| permission | | | |
| Only participants | False | True | True |
| explicitly given | | | |
| permission | | | |
| Only participants | False | False | False |
| explicitly given | | | |
| permission | | | |

Table 1 illustrates an example of how the collection policies and individual permissions work to grant or deny permission. In this example, the truth table is determining a result of whether an individual active participant can set discoverability options for external users.

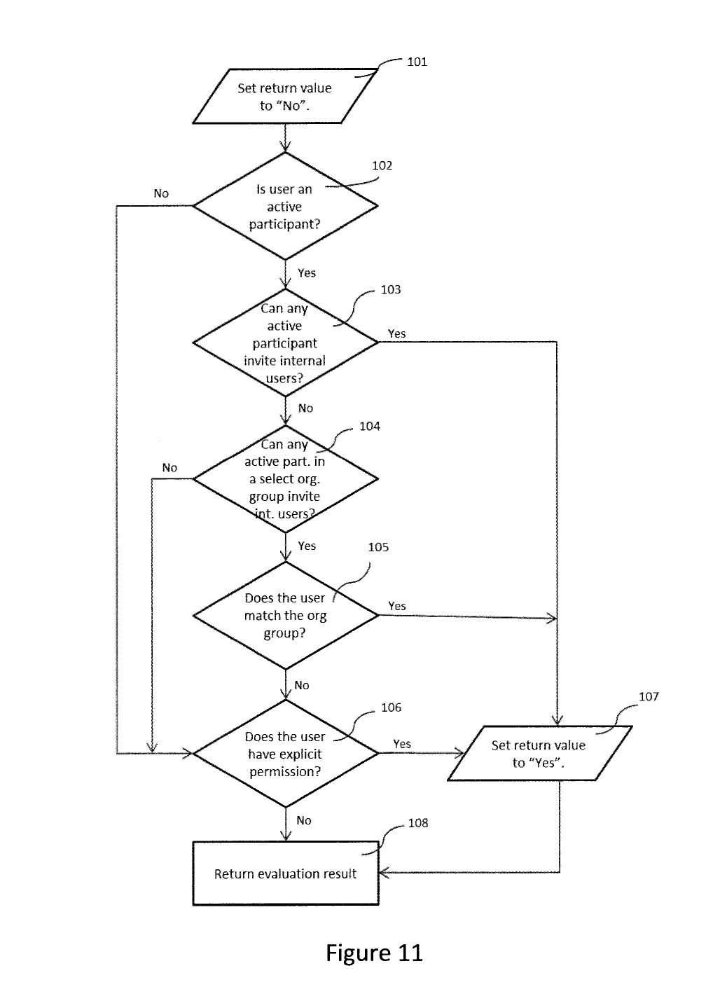

FIG. 11 shows the evaluation of permissions to invite internal other users to participate in a collection. Before a user 204 can participate in a collection, it must first be allowed 101. If the user is a passive participant 102, it must have explicit permission 106 to invite other users to participate 107 in the collection. If the user is an active participant 102, it can have permission generally 103 to invite others to participate 107 in the collection. If not, the collection may allow users that belong to a selected organisation group 104 to invite users to participate in the collection if they are members of the group 105. The results of the evaluation are then returned 108 so as to allocate the permissions.

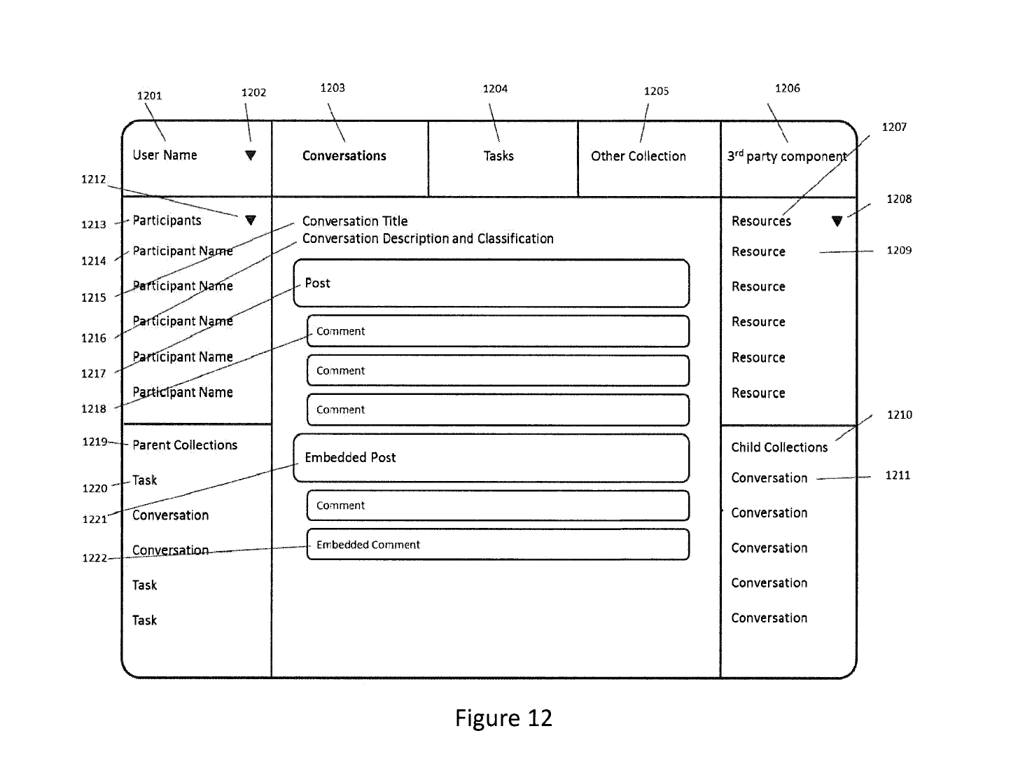

FIG. 12 illustrates a user interface according to an embodiment of the present invention. The user interface is an example of how the connected collections are outputted and displayed to users so that they can better participate in a collection with greater understanding of the collection. The embodiment shown in this figure focuses on a conversation collection 1215. It can be seen that a user 1201 can view posts 1217 and comments 1218 made by other participants 1213 in the conversation collection 1215. The user 1201 can also enter a post 1217, comment 1218 or embed a post 1221 from another collection. The conversation collection 1215 has a number of connected resources 1207 that the user 1201 can access. The conversation collection 1215 is also connected to (part of) parent collections 1219 including tasks 1220 and conversations. The conversation collection 1215 has a number of its own child collections 1210. Participants 1213 can also be invited and managed 1212 within the conversation collection 1215 by the participant 1214 who is the owner. The user 1201 can access other conversation collections 1203, task collections 1204, any other collections 1205 and third party components with connected collections 1206.

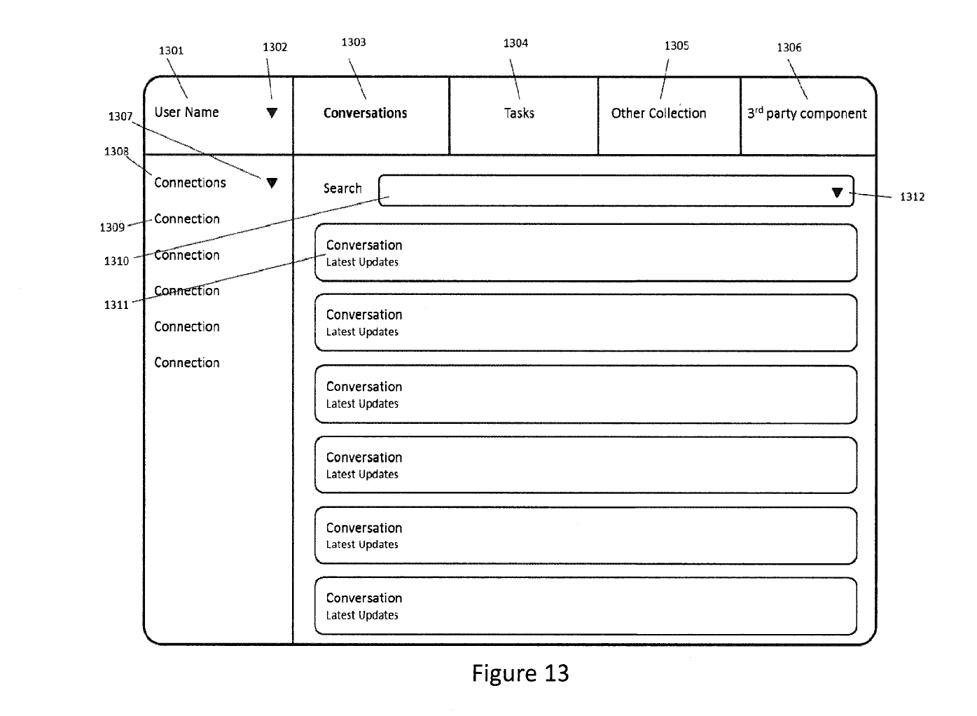

FIG. 13 illustrates a list of conversation collections 1303. Within this list are individual conversation collections 1311 in which the user 1301 is a participant. The search 1310 mechanism is used by the user 1301 to find collections that match a search string 1310. The search mechanism is implemented by the categorisation module of the controller 202, as described above. That is, the categorisation module 213 enables the classifying of collections with designated keywords so that the collections are searchable by users based on the keywords. These key words are entered into the search string 1310 by users wishing to search for the collections. In addition, it will be appreciated by those persons skilled in the art that users 1301 can also search other properties of the collection such as title, description, resource name, creation date of information (e.g., date of post), collections participated upon by the users, etc. It can also be seen in FIG. 13 that the user 1301 can search across conversation collections 1303 or by designated choices 1312 across other types of collections.

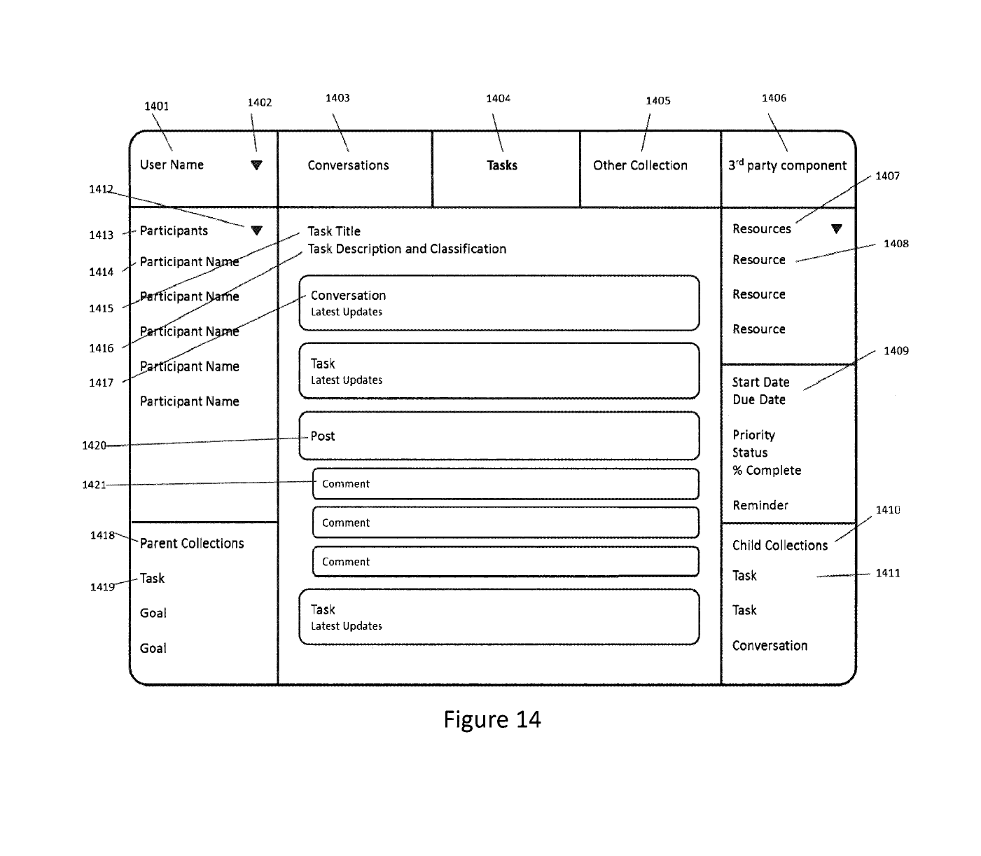

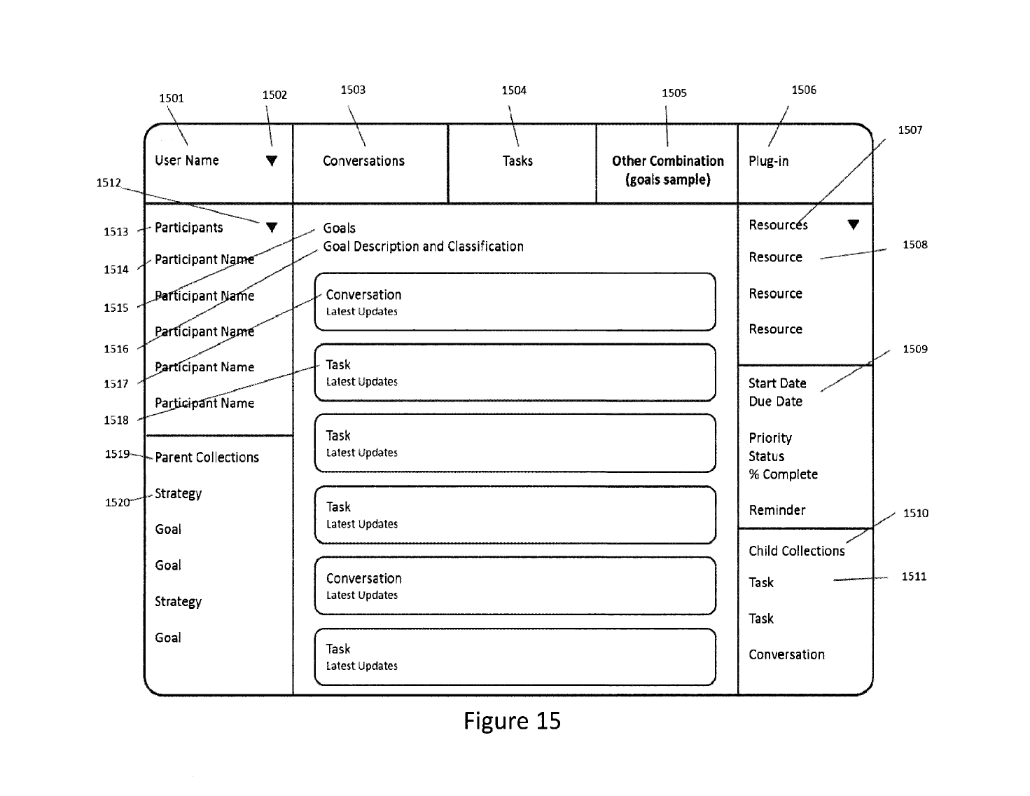

FIG. 14 illustrates a task collection 1415. As described, a task is a collection for a goal orientated purpose and can include a number of other collections and assembled information. The task collection 1415 shown in FIG. 14 is a special purpose instrument 1409 that collects other collections, such as the conversation 1417, post 1420 and comment 1421, for that purpose. That is, the task collection 1415 includes its own posts 1420, comments 1421 and resources 1407 which are understandings of the task. The task collection also has a number of child collections 1410 which appear within the task as objects 1417. The task collection 1415 is connected to greater parent collections 1418 including other tasks 1419 and goals. FIG. 15 illustrates a goal collection 1515. Like the task collection 1415 and other collections, it is a special purpose instrument 1509 that also collects understandings relating to the goal, such as the conversation 1517 and the task 1518, for that purpose.

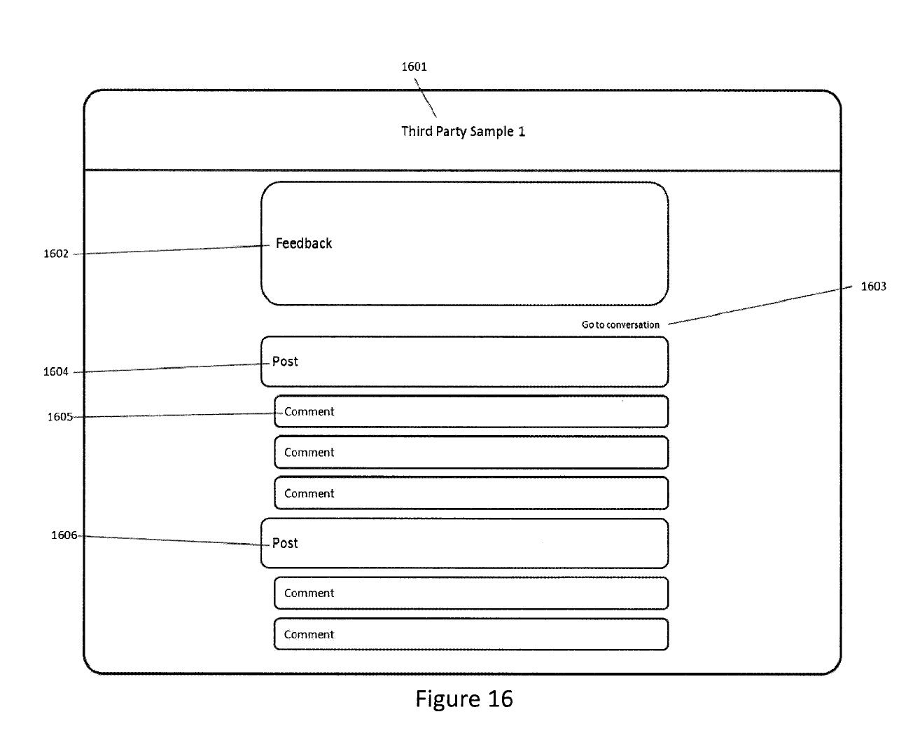

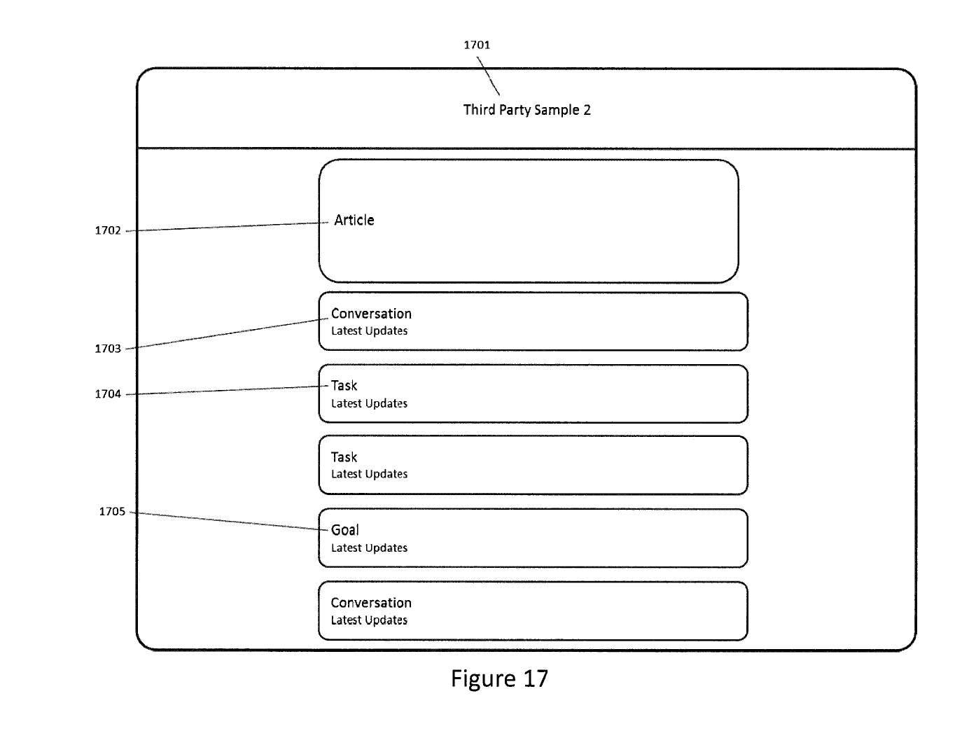

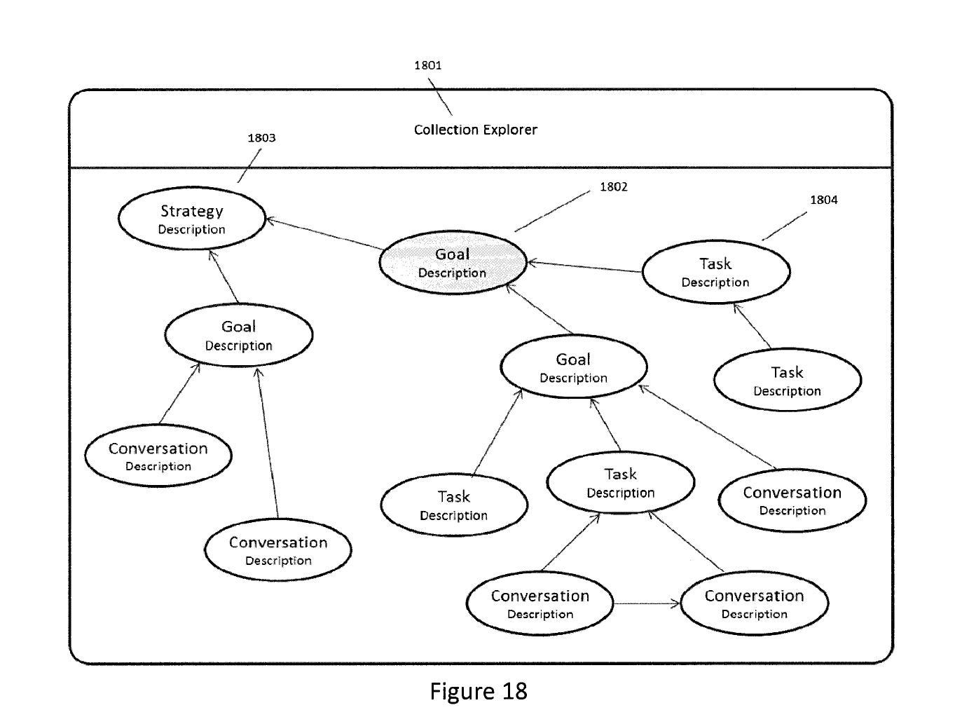

FIG. 16 illustrates a third party item feedback 1602 interfacing with the system to create a collection 1603. FIG. 17 illustrates a third party item 1702 interfacing with the system to create a series of linked collections 1703, 1704, 1705. FIG. 18 illustrates a graphical view in which a user 204 can explore connected collections 1801 in which they are participating or which are discoverable by them. In this figure, the user has selected collection 1802, which has a number of parent 1803 and child 1804 collections. On choosing another collection, connected collections will be evaluated and redisplayed within a designated number of levels of connection as described above. In this way the user can explore connected collections to increase their understanding of the selected collection 1802.

Referring back to FIG. 2, there is shown a summary of a computer implemented method 214 of managing information for user participation. The method 214 includes the steps of assembling 214 data indicative of information created by users 204 participating in a designated task or conversation into a collection, generating 218 a collection identifier for the collection, connecting 220 the collection to a further collection if the information created by the users 204 is related to information assembled within the further collection, generating 222 an edge connection in association with the collection identifier and a further collection identifier generated for the further collection, outputting 224 the collection and the further collection for the users 204 to participate in the task or the conversation based on the collection identifier for the collection and the edge connection.

Further aspects of the method will be apparent from the above description of the system. Persons skilled in the art will also appreciate that the method could be embodied in program code. The program code could be supplied in a number of ways, for example on a tangible computer readable medium, such as a disc or a memory or as a data signal or data file (for example, by transmitting it from a server).

It is to be understood that various alterations, additions and/or modifications may be made to the parts previously described without departing from the ambit of the present invention, and that, in the light of the above teachings, the present invention may be implemented in software, firmware and/or hardware in a variety of manners as would be understood by the skilled person.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

It is to be understood that various alterations, additions and/or modifications may be made to the parts previously described without departing from the ambit of the present invention, and that, in the light of the above teachings, the present invention may be implemented in software, firmware and/or hardware in a variety of manners as would be understood by the skilled person.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

What is claimed is:

1. A computer implemented method of managing information for user participation, the method comprising:
assembling data indicative of information created by users participating in a designated task or conversation into a collection;
generating a collection identifier for the collection;
connecting the collection to a further collection if the information created by the users is related to information assembled within the further collection;
generating an edge connection in association with the collection identifier and a further collection identifier generated for the further collection; and
outputting the collection and the further collection for the users to participate in the task or the conversation based on the collection identifier for the collection and the edge connection.

2. A method as claimed in claim 1, further comprising storing the collection identifier and the edge connection in a database.

3. A method as claimed in claim 1, wherein the information includes resources provided by providers.

4. A method as claimed in claim 1, further comprising assembling data indicative of the users participating in the task or the conversation in the collection, whereby the users include active and passive participants in the task or the conversation.

5. A method as claimed in claim 4, further comprising allocating security permissions for the users to participate in the task or the conversation in the collection based on whether the users are active or passive participants in the task or the conversation, whereby the active participants have been invited to participate in the task or the conversation and the passive participants have not been invited to participate in the task or the conversation.

6. A method as claimed in claim 5, further comprising removing the security permissions for said users to participate in the task or the conversation in the collection in response to the data indicative of said active and said passive participants being removed from the collection.

7. A method as claimed in claim 1, further comprising classifying the collection with one or more designated keywords such that the collection is searchable by the users based on the one or more designated keywords.

8. A method as claimed in claim 7, further comprising the users classifying the collection with one or more user designated keywords such that the collection is searchable by said users who have classified the collection based on the one or more user designated keywords.

9. A method as claimed in claim 1, further comprising allocating discoverability permissions for the users to control user discovery of the collection.

10. A method as claimed in claim 9, further comprising allocating the discoverability permissions to the collection for said users based on whether the users are active or passive participants in the task or the conversation in the further collection.

11. A system for managing information for user participation, the system including:
a collection module for assembling data indicative of information created by users participating in a designated task or conversation into a collection, wherein the collection module generates a collection identifier for the collection;
a connection module for connecting the collection to a further collection if the information created by the users is related to information assembled within the further collection, wherein the connection module generates an edge connection in association with the collection identifier and a further collection identifier for the further collection; and
an output module for outputting the collection and the further collection for the users to participate in the task or the conversation based on the collection identifier for the collection and the edge connection.

12. A system as claimed in claim 11, wherein the collection module stores the collection identifier and the connection modules stores the edge connection in a database.

13. A system as claimed in claim 11, wherein the information includes resources proved by providers.

14. Computer program code which when executed implements the method of claim 1.

15. A tangible computer readable medium comprising the program code of claim 14.
